(19) United States
(12) Patent Application Publication
(10) Pub. No.: US 2017/0228749 A1
(43) Pub. Date: Aug. 10, 2017

(54) System and Method of Facilitating Dynamic Price Adjustment

(71) Applicants: Bruno Larvol, San Francisco, CA (US); Christian Hayden, Chicago, IL (US)

(72) Inventors: Bruno Larvol, San Francisco, CA (US); Christian Hayden, Chicago, IL (US)

(73) Assignee: Larvol, San Francisco, CA (US)

(21) Appl. No.: 15/015,421

(22) Filed: Feb. 4, 2016

(51) Int. Cl. G06Q 30/02; G06Q 10/10

(52) U.S. Cl. CPC G06Q 30/0206; G06Q 10/1053

(57) ABSTRACT

A method is provided comprising a computer posting a work order comprising a first quantity of tasks available for work at a first price per task and a completion deadline for the first quantity of tasks. The computer receives a claim of the order from a first job seeker device, the claim comprising an offer to fulfill the order. The computer accepts the offer and instructs the device to begin work. The computer determines, at a first time before the deadline, a first actual job completion velocity of the order comprising a number of tasks of the first quantity completed at the first time compared to the first quantity. The computer adjusts at least one of the first price per task and the deadline based on comparison at the first time of the first actual and expected completion velocities for that time.

### PRIORITY CLAIM

This application claims priority to provisional application 62/269,442 filed Dec. 18, 2015.

### FIELD OF INVENTION

The present disclosure relates to the field of online work management systems. More specifically, the present disclosure relates to a system and method of facilitating dynamic price adjustment in an online work environment.

### BACKGROUND

Parties that have work in need of completion seek workers with specific skill sets, compensation expectations and schedule availabilities. Such parties, or job creators, with available work may publish such needs including a description of tasks, price per task, expected duration, and required qualifications of workers. Parties seeking such work, or job seekers, may make public the type of work they seek and their compensation requirements, schedule availabilities, and qualifications. Such job creators and job seekers desire venues to announce their presence, describe their needs, meet, and exchange information.

In a free market, job creators and job seekers may freely exchange information, negotiate, and reach agreement on price, duration, and other specifics of work engagements. As availability of work and availability of parties that can perform the work change, prices for units of work rise and fall according to free market supply and demand dynamics. A free and fluid market supports dynamic and rapid changes in pricing based on changing availability of work and availability of parties to competently perform the work.

Outsourcing of work by job creators for claiming and completion by job seekers is an example of how a free market environment supports determination of equilibrium and fair pricing for work. A large number of job creators and a large number of job seekers having unfettered access to each other supports market efficiencies that lead to stable pricing and opportunities for both job creators and job seekers to achieve prosperity.

### SUMMARY

In an embodiment, a method is provided. The method comprises a computer posting a work order comprising a first quantity of tasks available for work at a first price per task and a completion deadline for the first quantity of tasks. The method also comprises the computer receiving a claim of the work order from a first job seeker device, the claim comprising an offer to fulfill the work order as posted. The method also comprises the computer accepting the offer and instructing the first job seeker device to begin work on the work order. The method also comprises the computer determining, at a first time prior to the completion deadline, a first actual job completion velocity of the work order comprising a number of tasks of the first quantity completed at the first time compared to the first quantity. The method also comprises the computer adjusting at least one of the first price per task and the completion deadline based on a comparison of the first actual job completion velocity with an expected job completion velocity at the first time.

In an embodiment, a dynamic price adjustment system is provided. The system includes a processor, a memory and a dynamic price adjustment application stored in the memory that, when executed on the processor posts a work order comprising a first quantity of tasks available for work at a first price per task and a completion deadline for the plurality of tasks. The system also receives a claim of the work order from a first job seeker device, the claim comprising an offer to fulfill the work order as posted. The system also accepts the offer and instructs the first job seeker device to begin work on the work order. The system also determines, at a first time prior to the completion deadline, a job completion velocity of the work order comprising a number of tasks of the first quantity completed at the first time compared to the first quantity. The system also adjusts at least one of the first price per task and the completion deadline based on a comparison of the determined job completion velocity with an expected job completion velocity at the first time.

In an embodiment, a non-transitory computer readable medium embodying a program executable in a computing device for facilitating dynamic price adjustment is provided. The program comprises a program code for posting a work order comprising a first quantity of tasks available for work at a first price per task and a completion deadline for the plurality of tasks. The program also comprises a program code for receiving a claim of the work order from a first job seeker device, the claim comprising an offer to fulfill the work order as posted. The program also comprises a program code for accepting the offer and instructing the first job seeker device to begin work on the work order. The program also comprises a program code for determining, at a first time prior to the completion deadline, a job completion velocity of the work order comprising a number of tasks of the first quantity completed at the first time compared to the first quantity. The program also comprises a program code for adjusting at least one of the first price per task and the completion deadline based on a comparison of the determined job completion velocity with an expected job completion velocity at the first time.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to refer like/similar features and components.

FIG. 1 illustrates a network implementation of a system of facilitating dynamic price adjustment in accordance with an embodiment of the present disclosure.

FIG. 2 illustrates a flowchart of a method of facilitating dynamic price adjustment in accordance with an embodiment of the present disclosure.

### DETAILED DESCRIPTION

Systems and methods of dynamic price adjustment provided herein promote a work aggregator, distributor, or outsourcer to receive groups of tasks from work or job creators, establish pricing and completion deadlines for the tasks, and post the tasks for claiming and completion by qualified job seekers. As groups of tasks, or work orders, are moving toward completion, systems and methods measure the ongoing progress of the job seekers in completing the tasks.

A job completion velocity metric may be calculated at a given point prior to completion and compared to an expected job completion velocity for that point. Such an actual job completion velocity is the actual percentage of jobs or tasks completed at a given time of the total number of tasks in a work order. An expected job completion velocity is a predetermined expected percentage of tasks completed at that same given time. Comparing actual job completion velocity with expected job completion velocity at a given point prior to completion provides insights as to how a job seeker is performing as well as the appropriateness of pricing arrangements and completion deadlines that were established at the outset of the work order. Based on comparison of actual and expected job completion velocities at a point during completion of a work order, adjustments may be made.

Systems and methods provide for the price initially set for a work order to be increased or decreased based on actual job completion velocity. Further, the completion deadline for a work order may be shortened or extended based on actual job completion velocity calculated at a given time. Adjustments may be made to both pricing and completion deadline at the same and different times during the duration of a work order. Such adjustments are made to realign at least one of pricing and completion deadline with actual progress to that particular point and adjust the parties' expectations regarding the remainder of the work order.

The system seeks to establish and maintain pricing and completion scheduling that is acceptable and fair to both job creators who wish to have their work orders completed within budget and on time and job seekers who wish to be paid a fair income for their labor and work within scheduling that is agreeable. For various kinds of work orders that require differing workforce qualifications, skillsets and competencies, the system seeks to determine and maintain equilibrium pricing and scheduling levels that cultivate and support satisfaction of both job creators and job seekers over extended periods. Such equilibrium may also support a sustaining flow of business for parties that may operate such dynamic price adjustment systems.

The system also stores extensive records on past performance by job seekers who have completed all or part of past work orders. Analysis of such performance may enable both the system and job creators to make determinations about prospects for particular job seekers to perform during future engagements. Information is also stored about professional qualifications and certifications of job seekers as the nature of some work orders, for example examining medical records, may require such qualifications and certifications.

Systems and methods also provide for recommendations to be made to job creators about pricing and work order completion times for various types of work orders. Such recommendations may be based on previous performance on the same or similar types of work by job seekers as well as the availability of particular skills that may be in demand. Demographics of job seekers also receive consideration. Such demographics include locality including time zones of job seekers and holidays during which some job seekers are likely to be unavailable to work, information that may be useful in determining availability of job seekers.

Systems and methods of dynamic price adjustment may be implemented in at least one network arrangement with a dynamic price adjustment application executing on at least one server. Work orders may be received from job creators using job seeker devices of various kinds. Claims and other information may be received from job seekers using various types of job seeker devices. The network arrangement may be hosted on a private network or on a public network such as the world wide web of the Internet.

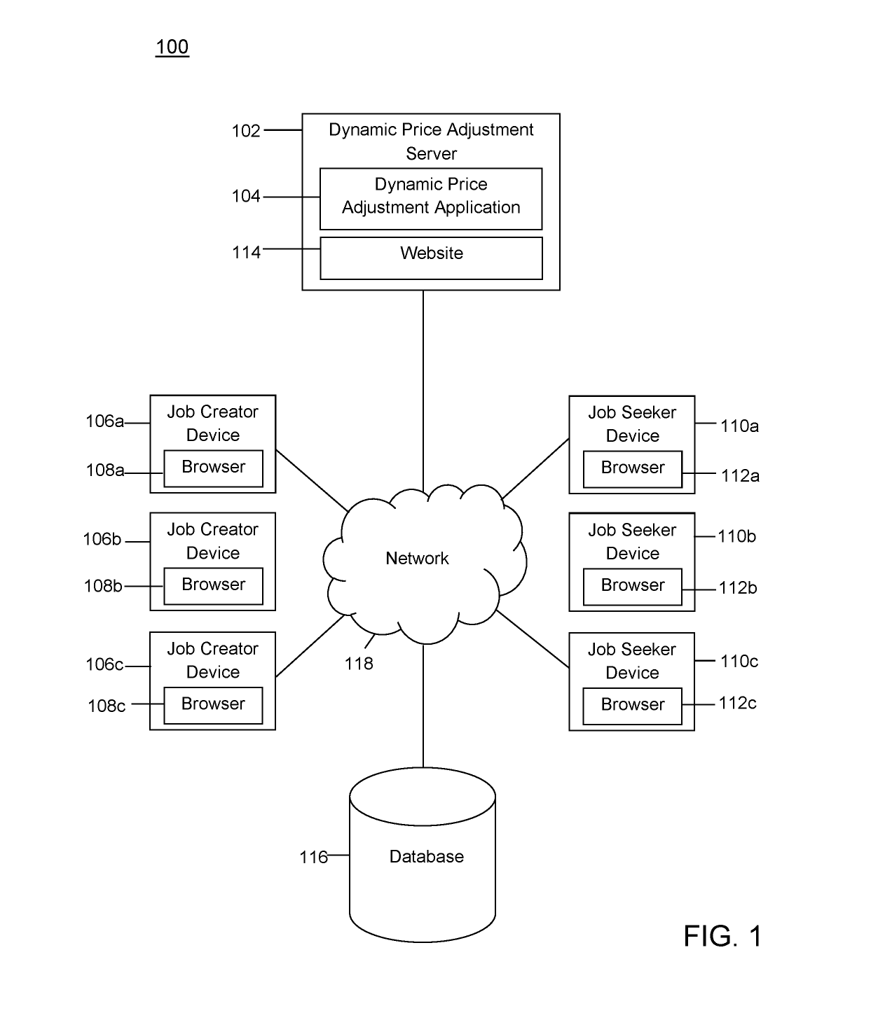

Turning to the figures, FIG. 1 depicts a block diagram of a system of facilitating dynamic price adjustment. FIG. 1 illustrates a system 100 provided herein comprising a dynamic price adjustment server 102, a dynamic price adjustment application 104, job creator devices 106-1, 106-2, 106-3, browsers 108-1, 108-2, 108-3, job seeker devices 110-1, 110-2, 110-3, browsers 112-1, 112-2, 112-3, a website 114, a database 116, and a network 118.

The dynamic price adjustment server 102, referred to hereinafter for discussion purposes as server 102, is a computer system. Computer systems are described in detail hereinafter. The server 102 may be operated or otherwise controlled by a firm or other entity or unit thereof in the field of work aggregation, work distribution, or outsourcing. In an embodiment, the firm may receive many work orders from internal or external parties, referred to herein as job creators, that wish to have tasks described by the work orders completed by competent parties, referred to herein as job seekers. The firm provides an electronic venue, for example the website 114, for fulfilling work orders for job creators by publishing the availability of the work orders for job seekers to view and claim. In providing such a venue, clearinghouse or marketplace where job creators and job seekers come together, the firm seeks to arrive at equilibrium prices for tasks of varying technical difficulties and completion schedules.

The dynamic price adjustment application 104 executes at least on the server 102. The dynamic price adjustment application 104, referred to hereinafter for discussion purposes as application 104, performs steps of methods provided herein. The application 104 receives, processes, and replies to messages sent by devices used by job creators and job seekers. The application 104 evaluates work orders and their component tasks submitted by job creators. The application 104 assists in setting pricing and completion deadlines for work orders. The application 104 analyzes and oversees progress on work orders once they have been begun by job seekers that successfully claimed the work orders.

Such oversight by the application 104 includes calculating job completion velocities which are measures of progress during the course of work orders. The application also suggests remedial action on ongoing work orders. Remedial action includes increasing and decreasing prices of tasks during the course of a work order based on progress being made. Remedial action by the application 104 also includes extending or shortening completion deadlines of work orders, also based on observed progress during the course of a work order.

System 100 also includes job creator devices 106-1, 106-2, 106-3, hereinafter job creator devices 106, which are used by job creators to submit work orders to the server 102. Job creator devices 106 may be desktop computers, laptop computers, and portable electronic devices including mobile telephones. The job creator devices 106-1, 106-2, 106-3 include browsers 108-1, 108-2, 108-3, respectively. Job creators or other users of the job creator devices 106-1, 106-2, 106-3 may use the browsers 108-1, 108-2, 108-3, respectively, to contact the server 102 to access the application 104 and avail themselves of the services described herein.

Job creators may be companies, healthcare providers, educational institutions, governmental units, nonprofit organizations or even private individuals who have work orders for which they are seeking competent parties to perform tasks described in the work orders. The work orders may each consist of a number of similar tasks, for example reviewing medical records. Job creators use their job creator devices 106-1, 106-2, 106-3 to contact the firm operating the server 102 and request assistance from the application 104 in promptly locating and contracting with job seekers with professional skills and schedule availability to complete work orders as needed by the job creators.

System 100 also includes job seeker devices 110-1, 110-2, 110-3, referred to hereinafter as job seeker devices 110, that are used by job seekers to respond to and claim work orders posted by the application 104 on the server 102 on behalf of job creator devices 106-1, 106-2, 106-3. Job seeker devices 110-1, 110-2, 110-3 may be desktop computers, laptop computers, and portable electronic devices including mobile telephones. Browsers 112-1, 112-2, 112-3 executing on the job seeker devices 110-1, 110-2, 110-3, respectively, may be used by job seekers or others in accessing the application 104 to review posted work orders, report on progress on outstanding work orders they are currently involved in, update their schedules including availability, and update their skillset information.

Job seekers may be organizations or private individuals or organizations employing individuals with skill sets, professional qualifications, and availability to perform tasks provided in work orders. Job seekers may use job seeker devices 110-1, 110-2, 110-3 and their respective browsers 112-1, 112-2, 112-3 to contact the server 102 to review and claim posted work orders and provide other information.

The website 114 executes on the server 102 or device associated with the server 102 and is widely accessible by job creator devices 106 and job seeker devices 110. The website 114, which is closely linked to or a component of the application 102, provides a venue for job creator devices 106 to post and manage work orders and for job seeker devices 102 to review and claim work orders.

In an embodiment, the website 114 is operated by an entity separate from the firm operating the server 102 and application 104. The firm may contract with the separate entity for web hosting and other services provided by the entity operating the website 114. The firm operating the server 102 and application 104 may operate the website 114 in the same or similar manner as if the firm were hosting the website 114 on its own equipment. In an embodiment, whether the website 114 is hosted by the firm operating the server 102 and application 104 or by a third party entity separate from the firm is transparent to users of job creator devices 106 and users of job seeker devices 110.

The database 116 stores information about job creators and their histories with the application 102 and further stores information about job seekers and their work histories, preferences, demographic information and skill sets. The database 116 also contains data about work orders previously handled by the application 102 including analyses of the accuracy of initial pricing of work orders and of the accuracy of initially set completion deadlines versus actual results. The database further contains data about past situations wherein pricing arrangements and completion deadlines needed to be changed prior to completion of the work orders. Associated information about job completion velocities of various work orders is also stored, including initial job completion velocities set for work orders at the beginning of the work orders and how actual job completion velocities worked out during the course of the work orders. Such information about actual versus expected job completion velocities is used by the application 102 to advise job creators on and/or setting pricing and completion deadlines for new work orders.

As with the website 114, the database 116 may not be directly associated with the server 102. The database 118 may instead be owned and/or operated by a party separate from the firm operating the server 102 and application 104 and the firm may be contracting with the owner/operator of the database 118 for access thereto. The database 114 may store data related to job creators and job creator devices 106, job seekers and job seeker devices 110, and other parties, devices and objects not related to the present disclosure.

The network 118 may be a wireless network, a wired network or a combination thereof. The network 118 can be implemented as one of the different types of networks, such as intranet, local area network, wide area network, or the internet. The network 118 may either be a dedicated network or a shared network. The shared network represents an association of the different types of networks that use a variety of protocols, for example, Hypertext Transfer Protocol (HTTP), Transmission Control Protocol/Internet Protocol (TCP/IP), and Wireless Application Protocol (WAP). The network 118 may include a variety of network devices, including routers, bridges, servers, computing devices, and storage devices.

The server 102 receives work orders from one or more job creator devices 106. The work orders comprise at least one task. The work orders may already contain price per task, completion deadline, and expected job completion velocities specified by the job creator devices 106. Expected job completion velocity is the expected percentage of tasks to be completed by a given point of the duration of a work order. Expected job completion velocity is typically set at the outset of a work order before work on component tasks has begun. Expected job completion velocity may be specified for various points along the way of a work order's duration. Actual job completion velocity is the calculated job completion velocity at the same given point of the duration. On behalf of a job creator, the application 104 may compare an actual job completion velocity calculated at a given point with the expected job completion velocity for that same given point. Analysis of the results of such a comparison may be used in making changes during the course of a work order's duration.

In a simplified example, a work order may consist of 100 tasks and have a completion deadline of two weeks. The job creator may specify a job completion velocity of 50% or 50 tasks to be completed at the one week mark, or half way to the completion deadline. Such a simplified example assumes a linear scenario of the 100 tasks being identical and the pace of work being uniform from beginning to end. In reality, the tasks may be of differing complexity as well as size and the job seekers may work at a slow pace at the beginning and work at an increasingly fast pace as they gain expertise, efficiency and confidence in dealing with the tasks. Initial setting of job completion velocities expected at various points during the duration of a work order may be influenced by both job creator needs for the work order to be completed on time without delay as well as complexity of tasks and familiarity of job seekers with the tasks and their known competencies.

The job creator may use expected job completion velocity to incentivize job seekers who have accepted and commenced a work order to work harder or more efficiently. Job creators have the right to alter pricing and completion deadlines during the course of work orders if the job creators determine that the job seekers are ahead of schedule or behind schedule. The application 104, with or without the direct instruction of the job creator, may reduce the price per task and shorten the completion deadline if the actual job completion velocity at a particular point is determined to be higher than the expected job completion velocity at that same particular point. In such an instance, it may be concluded that the tasks are easier than initially thought and that it makes sense to reduce what job seekers are being paid for the tasks or shorten the deadline so the job seekers may be freed to take on other work orders.

Conversely, the application 104 functioning alone and/or based on input from a job creator device 106 may increase the price per task and/or extend the completion deadline based on observations made during the course of a work order's completion. As previously, such action may be based on a comparison of actual job completion velocity calculated at a given point with the expected job completion velocity for that same given point. In this instance, the actual job completion velocity calculated at the given point may be lower than the expected job completion velocity for that point. It may be concluded that the tasks are more difficult than initially thought and that it makes sense to increase what job seekers are being paid and/or extend the completion deadline to give the job seekers more time to complete the tasks.

Posted work orders may be claimed by at least one job seeker device 110. The job seeker associated with the job seeker device 110 may have certain qualifications (i.e., educational or professional qualifications) needed to perform tasks described in the posted work orders. In one example, the job creator requires the job seeker to review medical charts. The job creator may specify the qualifications of the job seeker required such that only the job seeker having the qualification specified may claim the work order. In one example, the job creator may stipulate that the work order is to be completed by a job seeker with a doctorate in medicine. If the job seeker has a doctorate in medicine, he/she may claim and begin work on the work order.

Further, the job creator may determine a price that would be paid for the work order and determine a pre-defined time/deadline by which the work order should be completed. The job creator device 106 may create the work order (e.g., medical chart reviews) to be completed by the job seekers. In one example, the job creator device 106 creates a work order consisting of 150 tasks and specifies that they be completed within a time period of 10 days. Further, the job creator device 106 may specify the price, for example $5 for each task.

The application 104 may track completion of the work order within the pre-defined time specified and the $5 per task price. The job creator device 106 creates the work order, for example medical chart reviews, by specifying the number of tasks, for example 150, to be completed within a time period of 10 days, indicating an expected job completion velocity of 15 tasks per day. The application 104 may track the number of tasks completed at any given time from the time work began on the work order of 150 tasks. For example, the job creator device 106 posts and the job seeker device 110 accepts the offer of the work order for 150 tasks on November 15 with the specified time to complete the jobs as November 25 and a specified price of $5 per task. The application 104 may track, for example, the number of tasks completed in the eight day period from November 15 to November 23.

After tracking, the application 104 may check completion of the work order, at the price defined, by the at least one job seeker at the given time, e.g., on November 23. The application 104 may check the completion of the work order to determine an actual job completion velocity for the work order.

After determining the actual job completion velocity, i.e., the number of tasks completed from the initial date to the given time, e.g., between November 15 and November 23, the application 104 may adjust the price or the completion deadline for the work order based on the actual job completion velocity. If the application 104 determines on November 23 that only 100 tasks have been completed, indicating an actual job completion velocity of 12.5 tasks per day, then the application 104 may adjust the price for the remaining tasks to $6 per task. Specifically, the application 104 may check and compare the actual job completion velocity on the given date (12.5 tasks per day) with the expected job completion velocity of 15 tasks per day and adjust the price for the remaining duration of the work order.

This analysis and actions by the application 104 are predicated on an assumption that at the outset of the work order in this example, the expected job completion velocity was set at the aforementioned 15 tasks per day, i.e. linearly across the duration of the work order. If the application 104 determines that the pre-defined time is not long enough for the job seekers to complete the work order, then the application 104 may adjust the pre-defined time to November 27. In one example, the application 104 may determine a lowest possible price for the tasks to be completed by the deadline. For the above example, the application 104 may determine the ideal price as $5.50 per task for the remaining tasks. In one implementation, the application 104 may suggest how many tasks may be completed by the given period of time (i.e., from the work order creation to the given time) based on tracking completion of the tasks.

After determining a price for a given work order, the application 104 may provide recommendations to the job creator device 106. The application 104 may provide the recommendations in order to induce the job creator to adjust/update the price or the completion deadline for the work order. To develop a price to recommend to the job creator device 106, the application 104 may analyze previously completed work orders. The application 104 may provide the recommendations by analyzing work orders previously completed by the at least one job seeker and other job seekers similar to the at least one job seeker. In one example, the application 104 may analyze similar work orders in existing data stored in the database 116. The previous work orders may be similar to pending new work orders based on the nature of the tasks involved including projected complexity and learning curve involved for job seekers. For example, the work orders that require medical practitioners with a doctorate in medicine to work on the work orders may be categorized as one group. Similarly, the work orders that require the job seekers who have previously completed at least 100 tasks successfully may be categorized as one group.

To generate the recommendations, the application 104 may analyze one or more factors. In one example, the one or more factors may include at least one of type of the work order, the expected duration, the price per task, and the required qualifications of the job seekers. The recommendations are provided to increase a likelihood of success of the work order being taken up by the job seekers. In one implementation, the application 104 may analyze an expertise required for the job seekers to handle the work order based on the determined price. The application 104 may analyze information corresponding to at least one of the factors, e.g., type of the job, the expected time, the price, the required qualifications of the job seekers. After analyzing the information, the application 104 provides recommendations to the job creator. In one implementation, the application 104 may analyze previous work orders with similar difficulty and similar expected completion deadlines.

The job creator may want to set the price of a work order at $5 per task wherein the job seeker must be a medical practitioner. The job creator would like the work order completed in two days. The application 104 analyzes the information based on similar previous work orders to recommend that the job creator increase the price to $6 per task. The recommendation to increase the price per task is provided to improve the likelihood of success that job seekers will claim the job. If the application 104 in its analysis determines that a job creator is setting a price per task that is either too high or too low in light of previous experience with the tasks and the job seekers who have handled such tasks, the application 104 may provide such analysis to the job creator. The job creator may be influenced to change its planned price in accordance with the analysis provided by the application 104.

In one implementation, the application 104 may provide the recommendations in the form of a report. The recommendations may be provided to the job creator such that the job creator may adjust/update the price of the work order. By adjusting the price, the job creator may be more likely to succeed in inducing a job seeker to claim the work order.

In the example above in which a job creator creates a work order consisting of 150 tasks at $5 per task with a completion deadline of ten days, the application 104 may calculate the actual job completion velocity at any given time during the course of the work order. If the application 104 concludes that the actual job creation velocity is falling short of the expected job completion velocity set previously for that particular point of the work order's duration, the application 104 may adjust the price, with or without the approval of the job creator, for remaining tasks of the work order.

When a calculated actual job completion velocity at a particular point falls short of the expected job completion velocity for that point, the application 102 may adjust the price of remaining tasks in the work order. The application 102 may raise the price of the remaining tasks to incentivize the job seekers to work harder and increase the rate of production. This experience may also inform decisions about how to price new work orders involving similar tasks that would be handled by job seekers similar to those working on the present work order.

Conversely, when a calculated actual job completion velocity at a particular point exceeds the expected job completion velocity for that point, the application 104 may also adjust the price of remaining tasks in the work order. The application 104 may reduce the price of the remaining tasks. Similarly, this experience may also inform decisions about how to price new work orders involving similar tasks that would be handled by job seekers similar to those working on the present work order.

The application 104 may adjust the price of tasks within work orders upward or downward based on observations of actual job completion velocity versus expected job completion velocity at various points during work order completion. The application 104 seeks to determine and maintain equilibrium in pricing such that job creators are satisfied that they are receiving perceived value in the work being done on their work orders. The application 104 similarly seeks work order pricing equilibrium to influence job seekers to claim work orders, perform acceptably, and feel satisfaction such that they return in the future to claim and complete further work orders.

In one implementation, the application 104 may adjust the price for the remaining tasks of an ongoing work order within a pre-defined threshold price. For example, a job creator posts a work order consisting of 100 tasks to be completed in 10 days at the price of $5 per task. At the time of posting, the job creator may specify an upper pre-defined threshold price and a lower pre-defined threshold price for the tasks contained within the work order. The job creator in this example may specify that the lower pre-defined threshold price is $2.50 and the upper pre-defined threshold price is $8. If after five days of work, the job seeker that claimed the work order and began work has completed only 30 of the 100 jobs, the application 104 may determine that the job seeker is not working at an acceptable speed or that job seekers are not claiming work orders comprising 100 total tasks fast enough to meet the job creator's requirements. To get the tasks completed by the job seekers in 10 days, the application 104 may adjust the price per task to $7.50. When the application 104 adjusts the price, the application 104 may not set the price beyond the upper pre-defined threshold price for the tasks ($8 in this example). Similarly, if the job seekers complete the tasks at a rate that indicates that all tasks will be completed significantly before the deadline, then the application 104 may adjust the price to within the lower pre-defined threshold price, e.g., $2.50 per task. In one implementation, the application 104 may determine the threshold price based on prices set for previous tasks. The application 104 may analyze prices determined for previous tasks and set an upper threshold price and a lower threshold price for the tasks.

The application 104 may adjust the price automatically/dynamically for the remaining tasks in an incremental manner. The application 104 may adjust the price incrementally by analyzing the actual job completion velocity at the given time. Similarly, the application 104 may adjust the price automatically/dynamically for the remaining tasks in a decremental manner. The application 104 may adjust the price in a decremented manner by analyzing the actual job completion velocity at the given time.

To illustrate the application 104 increasing or decreasing the price automatically, in an example a job creator creates a work order of 100 tasks with a completion deadline of 10 days at a price of $4 per task. Five days after the date of work order commencement, if the job seekers have completed 30 tasks, then the application 104 may determine that the job seekers are not completing the tasks fast enough. In one implementation, the application 104 may increase or decrease the price for the two or more tasks by a percentile from the initially set price. The application 104 may increase or decrease the price to get the tasks completed by the job seekers. For the above example, in order to get the tasks completed by the job seekers in ten days, the application 104 may systematically increase the price for the remaining tasks by 10% per task each time; i.e., the application 104 may increase the price for the remaining tasks to $4.40 per task. In one example, the application 104 may increase the price for the remaining tasks by 15% per task from the original price. Further, after eight days from the job creation, if the job seekers have completed only 60 tasks even after the increase in price for the remaining tasks, then the application 104 may further increase the price for the remaining tasks.

For the above example, the application 104 may increase the price for the remaining 40 tasks by 20% from the original/first price, i.e., $4.80 per task for the remaining tasks. Similarly, if the application 104 determines that the job seekers have completed tasks at a rate that indicates that all tasks will be completed significantly before the deadline then the application 104 may decrease the price for the remaining tasks, e.g. by 10% from the original price. In one implementation, the application 104 may increase or decrease the price once in an hour, or a day, or a week, and so on. The application 104 may increase the price based on preferences set by the job creator at the time of tasks' creation. In one implementation, the application 104 may increase or decrease the price based on a history of the price set by the job creator.

In one implementation, the application 104 may adjust the price for the two or more tasks remaining with a minimum variance. For the above example, the application 104 may increase the price for the remaining tasks by 10% at first and then by 20%. When the application 104 is adjusting the price for the remaining tasks, the application 104 may not increase the price for the remaining tasks that has high variance from the price determined at first instance, e.g., by greater than 50% from the original price. Similarly, the application 104 may decrease the price for the remaining tasks by 10% at first and then 20%. When the application 104 is adjusting the price for the remaining tasks, the application 104 may not decrease the price for the remaining tasks that has high variance from the price determined at the first instance, e.g., by greater than 50% from the original price.

In another implementation, the application 104 may adjust the price with the minimum variance based on an upper limit and a lower limit determined for the two or more tasks. In order to explain determining the upper limit and the lower limit for the two or more tasks while adjusting the price, an example may be used. Considering the above example, the application 104 may determine that the minimum variance of the price as 10% from the original price. For the remaining tasks, the application 104 may determine the upper limit as 35% of the original price of the task. When the application 104 adjusts the price for the remaining tasks, the price of the task is increased by 10%, followed by 20%, followed by 30% and up to a maximum of 35% of the original price. The application 104 does not increase the price beyond the upper limit determined. Similarly, the application 104 determines the lower limit and adjusts the price of the task to within the lower limit. In another implementation, the application 104 may adjust the price for the remaining tasks by a unit of currency, e.g., 10 cents per task, 20 cents per task and so on. For the above example, the application 104 adjusts the prices for the remaining tasks as $5.10, $5.20, and so on. As presented above, the application 104 may determine the upper limit while adjusting the price. For the above example, the application 104 may adjust the price for the task up to the upper limit of 50 cents per task from the original price, i.e., $5.50.

In one implementation, the application 104 may project a likelihood of success regarding whether job seeker(s) are going to succeed in completing a new work order at the price and the pre-defined time specified for the new work order. To project the likelihood of success, the application 104 may review similar work orders previously completed by the job seeker(s) and project whether the job seeker(s) can complete the new work order at the price and the pre-defined time contemplated for the new work order. For example, consider the job creator has created a new work order with a specified price of $5 per task with a deadline of 5 days. The application 104 may analyze similar previous tasks completed by job seekers being considered for the new work order. If, after analyzing the previously completed tasks, the application 104 determines that the price specified for the new work order is less than what was paid to the job seekers for previous work orders similar to the new work order, then the application 104 may communicate to the job creator that the price specified for the new work order may be inadequate.

In one implementation, the application 104 may estimate the time that the job seekers will take to complete a work order when the job creator determines a certain price for the tasks within the work order. Similarly, the application 104 may recommend the price for the work order based on the time specified for the work order. In order to explain the above feature, an example is provided. The job creator may create a work order of 10 tasks of reviewing medical charts at a price of $5 per task. Based on the price determined, the application 104 may analyze the previous tasks completed and estimate the time the job seekers will take to complete the tasks. For example, the application 104 may estimate that the job seekers will take 10 days to complete the tasks if each task is priced at $5. Further, the application 104 may provide a prediction that if each task is priced at $6, then the job seekers will complete the tasks in 8 days. Similarly, the application 104 may analyze the time specified for the tasks to be completed and may provide recommendations to determine the price for the tasks.

In one implementation, the application 104 may check demography of the job seekers and provide recommendations to the job creator at the time of creation of work orders. For example, consider that each job seeker is situated in one of three countries: India, the United States, and Japan. Based on the demography of the job seekers, the application 104 may provide the recommendations. To provide the recommendations, the application 104 may analyze expected availability corresponding to the demography of the job seekers. In one implementation, the application 104 may check the demography to identify public holidays and time zones corresponding to the demography of the job seeker. After identifying details of the job seekers, the application 104 may provide the recommendations to the job creators. Consider the job creator is from US and the job creator creates the work orders specifying that the time to complete the work order is 10 days. Consider the job seekers who have completed previous work orders are from Japan. Consider there are three national holidays in Japan during the time specified by the job creator. After receiving details of the work orders, the application 104 may check the job seekers who have completed the work orders earlier and provide recommendations to the job creator. For the above example, the application 104 may determine that the people of Japan may not be working for three days due to the national holidays. Based on the analysis, the application 104 may provide the recommendations to the job creator to extend the time to 13 days from 10 days due to the national holidays in Japan. Based on the recommendation, the job creator may adjust the time to complete the work orders.

Similarly, the application 104 may analyze the time that the job seekers take to complete the work orders and provide recommendations to the job creator while creating the work orders. For example, consider the job seeker takes 10 days to complete five work orders. If the job creator specifies that five work orders should be completed in five days, then the application 104 may analyze the time the job seekers take to complete the work orders. Based on the number of days the job seekers take to complete the work orders, the application 104 may provide the recommendation to the job creator to adjust the time to 10 days. In order to provide the recommendations, the application 104 may analyze details of the work order completion stored in the database 116. For example, the application 104 may store the details of number of job seekers available to work on the tasks in the database 116. In another example, the application 104 may store the details of qualification of each job seeker in the database 116. The application 104 may retrieve stored details as needed.

In one implementation, the application 104 may capture a commitment made by the job seekers to provide recommendations to the job creator. The commitment may correspond to availability and non-availability of the job seeker. In one example, the job seekers may update their availability for a week in the database 116. Similarly, the job seekers may update how many work orders they may be able to complete in a particular time, e.g., in a day, or a week, a month, and so on. Based on the commitments made by the job seekers, the application 104 may provide recommendations to the job creator that some job seekers are not available during the pre-defined time specified for the work orders' completion, and recommend that the job creator extend the deadline.

In another implementation, the application 104 may check the number of job seekers available for claiming the work orders. In order to check the number of job seekers available, the application 104 may monitor a status of the job seekers. Specifically, the application 104 may monitor the status corresponding to the commitment made by the job seekers. After monitoring the status of each job seeker, the application 104 may determine the number of the job seekers available. For example, consider the job seekers having the qualification of doctorate have updated their commitment status on November 25. Consider 45 job seekers have committed themselves to being available and five job seekers have indicated that they will not be available on November 27. Before creating the work orders on November 25, the job creator may see that 45 job creators will be available on November 27 and create new work orders such that at least one job seeker from the 45 job seekers may claim the work orders and begin work. The new work orders may differ from previous work orders by having higher prices and/or longer deadlines due to there being few job seekers available than may have been the case previously.

In another implementation, the application 104 may obtain number of job seekers of a particular type available to work on the work orders at their time of creation. In order to obtain the number of job seekers available at the time of work order creation, the application 104 may check a status of the job seekers and expertise of the job seekers. Specifically, the application 104 may map the status of the job seekers in the database 116 with the expertise of the job seekers specified in the database 116. After mapping, the application 104 may present the number of job seekers of a particular type, e.g., job seekers with two years of experience in medical chart reviewing and available on the date of work order creation, to the job creator. Based on the number of job seekers available, the job creator may specify or modify the predefined time to complete the work order. For example, if 50 job seekers are available at the time of work order consisting of 100 tasks, then the job creator may specify the predefined time to complete the tasks as five days. Further, if only 20 job seekers are available and job creator has a work order comprising 100 tasks, then the job creator may specify the predefined time to complete the tasks as 15 days.

The application 104 may communicate to job seekers changes made to the pre-defined time or to the initial price of a work order. Although the dynamic adjusting of price may be provided within a crowdsourced environment, it is apparent to persons skilled in the art to incorporate the features disclosed herein in other online work environments such as e-commerce and web portals. Such implementations are within the scope of the present disclosure.

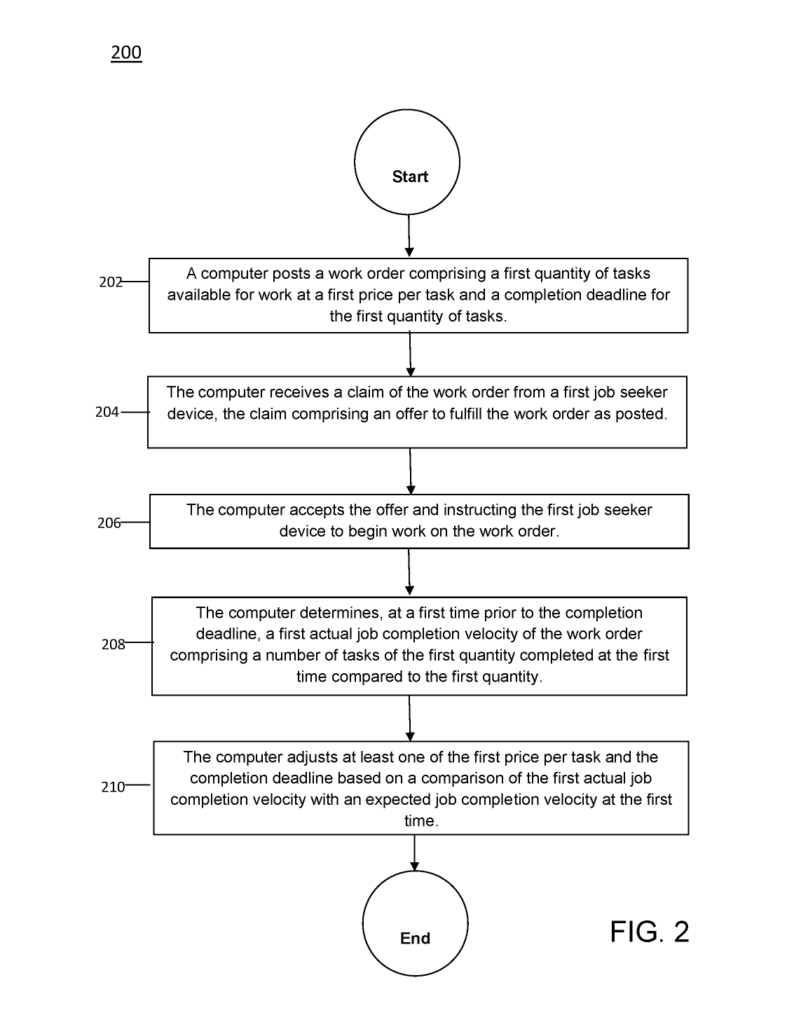

FIG. 2 depicts a flowchart of a method 200 according to an embodiment of the present disclosure. The steps of the method 200 may be performed by components provided by the system 100. Beginning at block 202, a computer posts a work order comprising a first quantity of tasks available for work at a first price per task and a completion deadline for the first quantity of tasks. At block 204, the computer receives a claim of the work order from a first job seeker device, the claim comprising an offer to fulfill the work order as posted.

At block 206, the computer accepts the offer and instructs the first job seeker device to begin work on the work order. At block 208, the computer determines, at a first time prior to the completion deadline, a first actual job completion velocity of the work order comprising a number of tasks of the first quantity completed at the first time compared to the first quantity.

At block 210, the computer adjusts at least one of the first price per task and the completion deadline based on a comparison of the first actual job completion velocity with an expected job completion velocity at the first time. The method 200 terminates thereafter.

Aspects of the system 100 described above may be implemented on a computer system with sufficient processing power, memory resources, and network throughput capability to handle the necessary workload placed upon it. The computer system includes a processor (which may be referred to as a central processor unit or CPU) that is in communication with memory devices including secondary storage, read only memory (ROM), random access memory (RAM), input/output (I/O) devices, and network connectivity devices. The processor may be implemented as one or more CPU chips.

Secondary storage is typically comprised of one or more disk drives or tape drives and is used for non-volatile storage of data and as an over-flow data storage device if RAM is not large enough to hold all working data. Secondary storage may be used to store programs which are loaded into RAM when such programs are selected for execution. The ROM is used to store instructions and perhaps data which are read during program execution. ROM is a non-volatile memory device which typically has a small memory capacity relative to the larger memory capacity of secondary storage. The RAM is used to store volatile data and perhaps to store instructions. Access to both ROM and RAM is typically faster than to secondary storage.

I/O devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), and/or worldwide interoperability for microwave access (WiMAX) radio transceiver cards, and other well-known network devices. These network connectivity devices may enable the processor to communicate with the Internet or one or more intranets. With such a network connection, it is contemplated that the processor might receive information from the network, or might output information to the network in the course of performing the above-described method steps. Such information, which is often represented as a sequence of instructions to be executed using at least one processor, may be received from and outputted to the network, for example, in the form of a computer data signal embodied in a carrier wave.

Methods provided herein may be described in the general context of computer executable instructions. Generally, computer executable instructions can include routines, programs, objects, components, data structures, procedures, modules, functions, etc., that perform particular functions or implement particular abstract data types. Methods may also be practiced in a distributed computing environment where functions are performed by remote processing devices that are linked through a communications network. In a distributed computing environment, computer executable instructions may be located in both local and remote computer storage media, including memory storage devices.

Although implementations of system and method of facilitating dynamic price adjustment have been described in language specific to structural features and/or methods, it is to be understood that the appended description is not necessarily limited to the specific features or methods described. Rather, the specific features and methods are disclosed as examples of implementations for price adjustment.

What is claimed is:

1. A method of facilitating dynamic price adjustment, comprising:
a computer posting a work order comprising a first quantity of tasks available for work at a first price per task and a completion deadline for the first quantity of tasks;
the computer receiving a claim of the work order from a first job seeker device, the claim comprising an offer to fulfill the work order as posted;
the computer accepting the offer and instructing the first job seeker device to begin work on the work order;
the computer determining, at a first time prior to the completion deadline, a first actual job completion velocity of the work order comprising a number of tasks of the first quantity completed at the first time compared to the first quantity; and
the computer adjusting at least one of the first price per task and the completion deadline based on a comparison of the first actual job completion velocity with an expected job completion velocity at the first time.

2. The method of claim 1, further comprising the computer receiving the work order from a job creator device, wherein the first price per task and the completion deadline are determined by one of the computer and the job creator device.

3. The method of claim 1, further comprising the computer posting the work order to a widely accessible venue with a plurality of additional work orders received from a plurality of job creator devices for review by a plurality of job seeker devices.

4. The method of claim 1, further comprising the computer at least one of reducing the price per task from the first price per task and shortening the completion deadline when the first actual job completion velocity is higher than the expected job completion velocity.

5. The method of claim 1, further comprising the computer at least one of increasing the price per task from the first price per task and extending the completion deadline when the first actual job completion velocity is lower than the expected job completion velocity.

6. The method of claim 2, further comprising a plurality of job creator devices and job seeker devices accessing the venue via web browser applications to post work orders and claim work orders, respectively.

7. The method of claim 6, further comprising the steps of the method implemented in a crowdsource environment.

8. The method of claim 1, further comprising the computer providing recommendations to the job creator device regarding pricing of tasks and completion deadlines of tasks in view of at least evaluations of qualifications of job seekers and demographic characteristics of job seekers.

9. A dynamic price adjustment system, comprising:
a processor;
a memory; and
a dynamic price adjustment application stored in the memory that, when executed on the processor:
posts a work order comprising a first quantity of tasks available for work at a first price per task and a completion deadline for the first quantity of tasks,
receives a claim of the work order from a first job seeker device, the claim comprising an offer to fulfill the work order as posted,
accepts the offer and instructs the first job seeker device to begin work on the work order,
determines, at a first time prior to the completion deadline, a job completion velocity of the work order comprising a number of tasks of the first quantity completed at the first time compared to the first quantity, and
adjusts at least one of the first price per task and the completion deadline based on a comparison of the determined job completion velocity with an expected job completion velocity at the first time.

10. The system of claim 9, wherein the application posts the work order to a widely accessible venue with a plurality of additional offered work orders received from a plurality of job creator devices for review by a plurality of job seeker devices.

11. The system of claim 9, wherein the application at least one of reduces the price per task from the first price per task and shortens the completion deadline when the determined job completion velocity is higher than the expected job completion velocity.

12. The system of claim 9, wherein the application at least one of increases the price per task from the first price per task and extends the completion deadline when the determined job completion velocity is lower than the expected job completion velocity.

13. The system of claim 9, wherein the application analyzes factors comprising at least one of completion deadline, a type of work associated with the work order, expertise and qualifications required to perform the work, and work histories and availability of prospective job seekers prior to providing recommendations to a job creator device regarding a price per task for the work order.

14. The system of claim 10, wherein the application further analyzes previous work orders similar to the work order prior to providing recommendations to a job creator device regarding a price per task and completion deadline for the work order.

15. A non-transitory computer readable medium embodying a program executable in a computing device for facilitating dynamic price adjustment, the program comprising:
a program code for posting a work order comprising a first quantity of tasks available for work at a first price per task and a completion deadline for the first quantity of tasks;
a program code for receiving a claim of the work order from a first job seeker device, the claim comprising an offer to fulfill the work order as posted;
a program code for accepting the offer and instructing the first job seeker device to begin work on the work order;
a program code for determining, at a first time prior to the completion deadline, a job completion velocity of the work order comprising a number of tasks of the first quantity completed at the first time compared to the first quantity; and
a program code for adjusting at least one of the first price per task and the completion deadline based on a comparison of the determined job completion velocity with an expected job completion velocity at the first time.

16. The non-transitory computer readable medium of claim 15, further comprising a program code for at least one of reducing the price per task from the first price per task and shortening the completion deadline when the determined job completion velocity is higher than the expected job completion velocity.

17. The non-transitory computer readable medium of claim 15, further comprising a program code for at least one of increasing the price per task from the first price per task and extending the completion deadline when the determined job completion velocity is lower than the expected job completion velocity.

18. The non-transitory computer readable medium of claim 15, further comprising a program code for classifying workforce segments associated with job creator devices into groups noted as qualified to handle certain types of tasks.

19. The non-transitory computer readable medium of claim 15, further comprising a program code for analyzing at least one work order of at least one of a specific type, of an expected completion time, of an expected price, and requiring specific expertise and qualification in developing recommendations regarding likelihood of success of a prospective workforce in completing the at least one work order.

20. The non-transitory computer readable medium of claim 15, further comprising a program code for receiving messages from a plurality of job seeker devices regarding workforce availability for a certain future period and recording the availability information in a database.
